(19) United States
(12) Patent Application Publication
(10) Pub. No.: US 2004/0195058 A1
(43) Pub. Date: Oct. 7, 2004

(54) Braking apparatus for motor vehicle

(75) Inventors: Eiji Ina, Toyohashi-city (JP); Hidetoshi Suzuki, Hamamatsu-city (JP); Atsushi Katou, Toyohashi-city (JP)

Correspondence Address: POSZ & BETHARDS, PLC, 11250 ROGER BACON DRIVE, SUITE 10, RESTON, VA, 20190, US

(73) Assignee: ASMO CO., LTD.

(21) Appl. No.: 10/814,514

(22) Filed: Apr. 1, 2004

(30) Foreign Application Priority Data
Apr. 2, 2003 (JP) 2003-99663

(51) Int. Cl. F16D 55/08

(52) U.S. Cl. 188/158

(57) ABSTRACT

A braking apparatus for a motor vehicle comprises a main braking device for applying braking force to wheels of the motor vehicle in response to a press stroke of a brake pedal, and a parking brake device operatively connected to the main braking device for applying parking brake force from an electric motor to the wheels at parking the motor vehicle, wherein a through-hole is provided in a housing of the parking brake device, through which a machine tool will be inserted to manually rotate the electric motor when the electric motor becomes out of order after the parking brake force is applied to the wheels, and a breathing pipe is detachably connected at its one end to the through-hole and terminated at its other end at a place, for example, a passenger room, where there are little extraneous material.

### CROSS REFERENCE TO RELATED APPLICATION

This application is based on Japanese Patent Application No. 2003-99663 filed on Apr. 2, 2003, the disclosure of which is incorporated herein by reference.

### FIELD OF THE INVENTION

The present invention relates to a braking apparatus for a motor vehicle, in particular, to such a braking apparatus for applying parking brake force based on driving force of an electric motor.

### BACKGROUND OF THE INVENTION

As prior art technology, a braking apparatus is known as shown in PCT Patent Application PCT/EP 98/04582 (Publication No.2001-510760). In this apparatus, main braking force is generated by working fluid in a braking system during a running of the motor vehicle, while a parking brake force is applied by means of an electric motor.

When the electric motor goes out of order due to some reasons after the parking brake is operated, the braking force is kept and thereby it becomes an obstacle for moving the motor vehicle.

In another prior art, such as a braking apparatus shown in Japanese Patent Publication 2001-234958, an interconnecting portion is provided at an end of a motor shaft and a through-hole is formed at a motor housing through which the end of the motor shaft is exposed to the outside of the motor housing. In this prior art, when the motor goes out of order after the parking brake is applied, a machine tool will be inserted into the motor housing through the through-hole so that the machine tool will be engaged with the interconnecting portion of the motor shaft. Then the motor shaft will be rotated by the machine tool so that the parking brake will be released.

The braking apparatus is provided to wheels of the motor vehicle, where the braking apparatus is exposed to extraneous material, such as rain water and dust. Therefore, the through-hole mentioned above is usually covered by a cap or plug to prevent the extraneous material coming into the motor housing.

In this prior art, however, since the cap or plug is a part specifically designed and manufactured for the braking apparatus, the number of parts will be increased. Furthermore, in the prior art, since the through-hole is completely covered (sealed) by the cap or plug, the breathing is not generally possible.

### SUMMARY OF THE INVENTION

It is, therefore, an object of the present invention, in view of the above mentioned problems, to provide a braking apparatus, in which the extraneous material, such as rain water and the dust may not easily come into a motor housing and furthermore breathing between the inside and outside of the motor housing is possible.

It is another object of the present invention to provide a braking apparatus, in which the manual operation of the electric motor from the outside can be easily done, when the electric motor goes out of order after the parking brake is operated.

According to a feature of the present invention, a through-hole is provided in a housing of an electric motor, through which a machine tool will be inserted to manually rotate the electric motor when the electric motor becomes out of order after the parking brake force is applied to wheels of a motor vehicle, and a breathing pipe is detachably connected at its one end to the through-hole and terminated at its other end at a place, for example, a passenger room, where there are little extraneous material.

According to another feature of the present invention, the through-hole is formed in the motor housing at such a position opposing to an interconnecting portion of the motor and the inner diameter of the through-hole is so made to be almost the same to a diameter of the machine tool. And thereby, the machine tool is prevented from being largely inclined from an axis of its manual operation.

According to a further feature of the present invention, a pipe portion is formed at the through-hole, which protrudes outwardly from the motor housing, so that the breathing pipe can be easily attached to and/or detached from the pipe portion.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross-sectional view, taken along a line I-I in FIG. 2, and showing an embodiment of a braking apparatus according to the present invention;

FIG. 2 is a view showing an inside of an actuator;

FIG. 3 is a cross-sectional view showing a condition at which a machine tool is inserted into the braking apparatus;

FIG. 4 is a cross-sectional view taken along a line IV-IV in FIG. 3;

FIG. 5 is a cross-sectional view of taken along the same line of FIG. 3 but showing a modification of the present invention;

FIG. 6A is a schematic diagram showing a machine tool; and

FIG. 6B is a schematic diagram showing another machine tool.

### DETAILED DESCRIPTION OF THE PREFERRED EMBODIMENTS

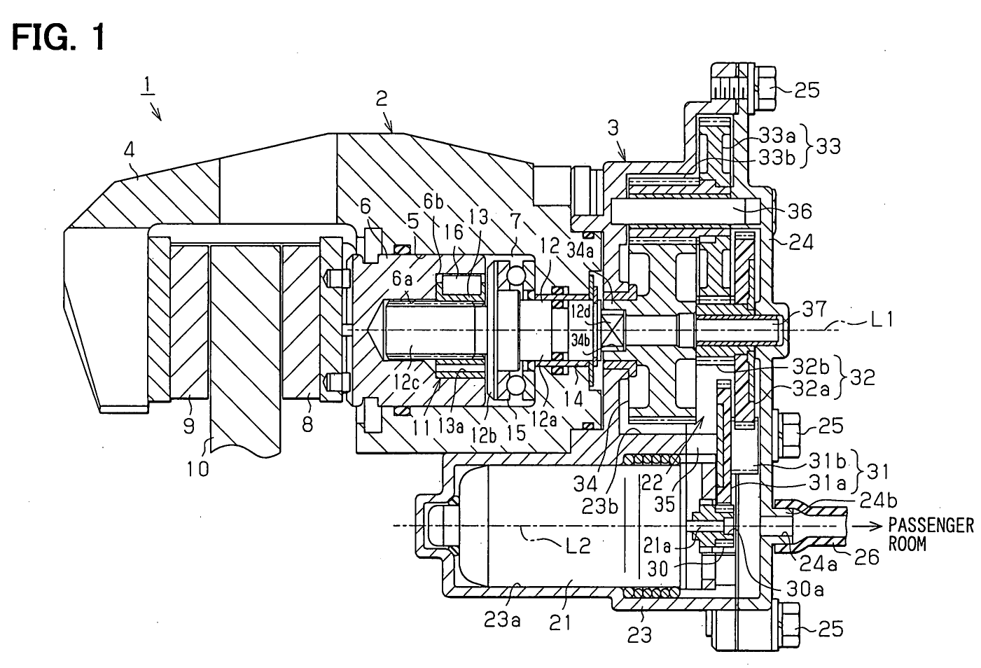

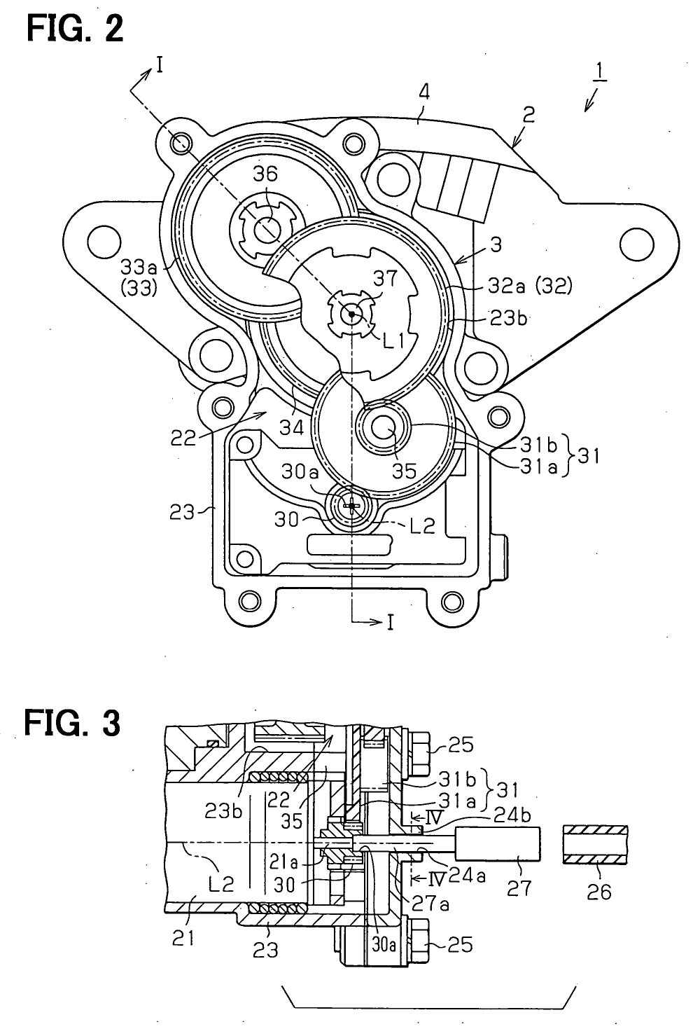

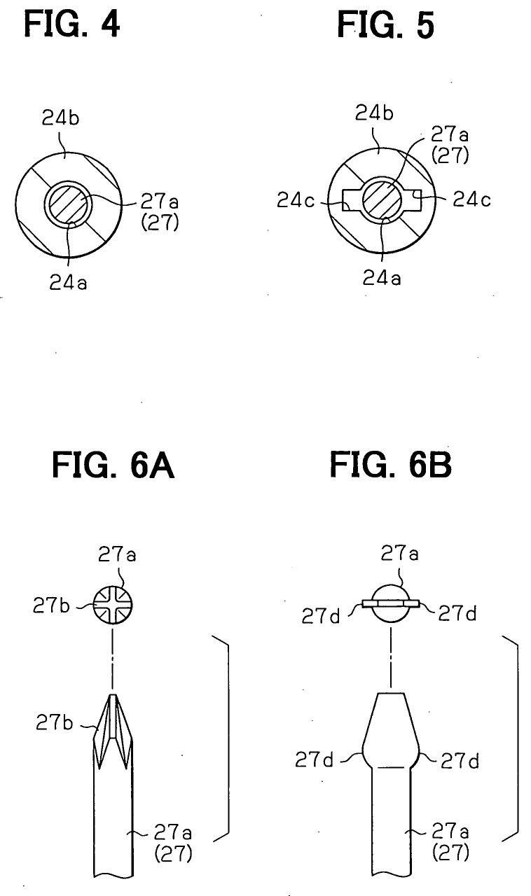

A braking apparatus for a motor vehicle according to the present invention will be now explained with reference to FIGS. 1 and 2. The braking apparatus 1 is provided to a wheel (not shown) of a motor vehicle (for example, to each of the rear wheels). The braking apparatus 1 applies braking force to the wheel in response to a pressure increase of braking fluid of a braking system, which is controlled by a brake pedal (main braking force during the motor vehicle is running) and also applies braking force to the wheel by an operational force of an electric motor controlled by a parking brake switch (not shown) when the motor vehicle is parked (parking brake force).

The braking apparatus 1 comprises a braking mechanism 2 and a parking brake actuator 3 operating as an electric actuator (parking brake device).

The braking mechanism 2 comprises a brake caliper 4 of a floating type having a piston cavity 5, in which a brake piston 6 is provided not rotationally but movably in a longitudinal direction. A fluid operating chamber 7 is formed by a space in the piston cavity 5 closed by a rear end (a right hand end in FIG. 1) of the brake piston 6, and braking fluid is filled into the fluid operating chamber 7.

A brake pad 8 working as a friction element is fixed to a front end (a left hand end in FIG. 1) of the brake piston 6. Another brake pad 9 working also as a friction element is provided in the brake caliper 4 at an opposing end to the brake pad 8, wherein the brake pads 8 and 9 constitutes a pair of the brake pads. A brake disc 10, which rotates together with the wheel, is positioned between the pair of the brake pads 8 and 9. The braking mechanism 2, the brake pads 8 and 9 and the brake disc 10 constitutes a main braking device.

When a pressing stroke of the brake pedal (not shown) becomes larger, the fluid pressure in the fluid operating chamber 7 increases in response to the pressing stroke, so that the brake piston 6 is forwardly moved towards the brake disc (in a leftward direction in FIG. 1). Then the brake pad 8 of the brake piston 6 will be moved and pressed against one side of the brake disc 10. In conjunction with the movement of the brake pad 8, the brake caliper 4 is moved so that the other brake pad 9 is likewise moved and pressed against the other side of the brake disc 10. As above, braking force is applied to the brake disc 10 (namely to the rear wheel).

When the pressing force to the brake pedal is decreased, the fluid pressure in the fluid operating chamber 7 decreases in response to the released stroke of the pedal, the brake piston is backwardly (in a rightward direction in FIG. 1) moved by, for example, reaction force generated at the brake pads 8 and 9 due to their pressing force against the brake disc 10. Then the pressing force of the brake pads 8 and 9 against the brake disc 10 will be decreased and the braking force will be reduced. When the brake pedal is fully released from the pressing force, the brake piston 6 further moves backwardly and thereby the brake pads 8 and 9 will be finally separated from the brake disc 10.

A power transmitting mechanism 11 is further provided in the brake caliper 4. The power transmitting mechanism 11 converts a rotational movement at an output shaft 34a of the parking brake actuator 3 to a reciprocal movement and transmits the movement to the brake piston 6 to operate the same. The power transmitting mechanism 11 comprises a screw shaft 12 and a nut element 13.

The screw shaft 12 is provided with a shaft portion 12a, a flanged portion 12b and screwed portion 12c from a rear end (a right hand end in FIG. 1) to a front end (a left hand end in FIG. 1) of the screw shaft 12.

The shaft portion 12a is rotationally supported by the brake caliper 4 through a radial slide bearing 14. The rear end of the shaft portion 12a protrudes from the brake caliper 4 and an interconnecting protruding portion 12d is formed at its protruded end, wherein the interconnecting protruding portion 12d has a pair of flat surfaces. Namely, the interconnecting protruding portion 12d is engaged with the output shaft 34a of the parking brake actuator 3, so that the rotational force of the output shaft 34a will be transmitted to the screw shaft 12.

The flanged portion 12b is positioned in the fluid operating chamber 7 and rotationally supported by the brake caliper 4 in such a manner that a rear side (a right hand side in FIG. 1) of the flanged portion contacts with a thrust ball bearing 15.

A screw is formed at an outer peripheral surface of the screw portion 12c, wherein the screw is formed by trapezoidal threads having a trapezoidal cross-sectional configuration. The screw portion 12c is engaged with the nut element 13, wherein the screw formed at an inner surface of nut element 13 is likewise formed with trapezoidal threads having a trapezoidal cross-sectional configuration. The screw portion 12c and nut element 13 constitute a self-locking mechanism, so that the rotational movement can be transformed to the reciprocal movement, while the reciprocal movement can not be transformed to the rotational movement.

The brake piston 6 is provided with a bore 6a for receiving the screw portion 12c and nut element 13 at the rear end thereof, wherein the bore 6a is formed with a step portion 6b, so that a front end (a left hand end in FIG. 1) of the nut element 13 will be contacted with a bottom end of the step portion 6b, when the nut element 13 is moved in a leftward direction. The bore 6a is communicated with the fluid operation chamber 7 and forms a part of the chamber 7. The nut element 13 is provided with a key element 16, so that a relative rotation of the nut element 13 with respect to the brake piston 6 is restricted. The nut element 13 is movable in a longitudinal direction in the bore 6a until the nut element 13 contacts with the step portion 6b.

When the screw shaft 12 is rotated in one direction (in a normal direction), the nut element 13 which is non-rotationally supported against the brake piston 6 will be moved in the leftward direction towards the front end of the screw portion 12c and forwardly pushes the brake piston 6 when the nut element 13 contacts with the step portion 6b. On the other hand, when the screw shaft 12 is rotated in a reversed direction, the nut element 13 is moved in the rightward direction towards the rear end of the screw portion 12c. In this operation, namely when the nut element 13 is moved in the rightward direction, the nut element 13 becomes out of contact with the step portion 6b.

As understood, when the brake piston 6 is forwardly moved by the pressure increase of the working fluid, the brake piston is moved independently from the nut element 13, since in this movement the nut element 13 will be separated from the step portion 6b. A through-hole 13a is further formed in the nut element 13 so that the working fluid is introduced from the fluid operation chamber 7 to the inside of the bore 6a to increase a pressure receiving area in the brake piston 6.

The parking brake actuator 3 is fixed to the braking mechanism 2 by means of multi bolts (not shown). The parking brake actuator (parking brake device) 3 comprises an electric motor 21, such as a DC motor, and a speed reduction mechanism 22 for reducing rotational speed of the motor 21. The electric motor 21 and the speed reduction mechanism 22 are respectively disposed in a motor receiving portion 23a and a reduction mechanism receiving portion 23b of a casing 23, and the casing 23 is covered by a cover 24 which is fixed to the casing by multi bolts 25. The casing 23 and the cover 24 constitute a housing for the parking brake device.

The electric motor 21 is inserted into and fixed to the motor receiving portion 23a, wherein a rotational axis line L2 is in parallel to a rotational axis line L1 of the brake piston 6 (the screw shaft 12) and a rotational shaft 21a protrudes to a direction opposite to the brake piston 6. A pinion 30 is fixed to the rotational shaft 21a.

When a parking brake switch (not shown) is turned on to operate the parking brake, electric power will be supplied to the electric motor 21 to rotate the same in the normal rotational direction until a predetermined braking force is applied to the brake disc by the braking mechanism 2 (namely, the brake pads 8 and 9 are pressed against the brake disc 10 at a predetermined pressure), and then the supply of the electric power will be cut off. When the parking brake switch is turned on to release the parking brake, the electric power will be supplied to the electric motor 21 to rotate the same in the reversed direction until the braking force applied to the brake disc by the braking mechanism 2 becomes zero (namely, the brake pads 8 and 9 become separate from the brake disc 10), and then the supply of the electric power is cut off.

The speed reduction mechanism 22 is disposed in the reduction mechanism receiving portion 23b at such a side of the brake piston 6 and opposite to the power transmitting mechanism 11. The speed reduction mechanism 22 comprises a first to fourth reduction gears 31 to 34, wherein the pinion 30 is one of the gears constituting the speed reduction mechanism 22.

The first reduction gear 31 comprises a large-diameter gear 31a and a small-diameter gear 31b, which are connected with each other to rotate as one unit and rotationally supported by a supporting shaft 35. The supporting shaft 35 is fixed to the casing 23 and the cover 24 so that an axis of the supporting shaft 35 is in parallel to the rotational shaft 21a of the electric motor 21 (the screw shaft 12). The large-diameter gear 31a of the first reduction gear 31 is engaged with the pinion 30. The second reduction gear 32 comprises a large-diameter gear 32a and a small-diameter gear 32b, which are connected with each other to rotate as one unit and rotationally supported by a supporting shaft 37 fixed to the fourth reduction gear 34. The large-diameter gear 32a of the second reduction gear 32 is engaged with the small-diameter gear 31b of the first reduction gear 31. The third reduction gear 33 comprises a large-diameter gear 33a and a small-diameter gear 33b, which are connected with each other to rotate as one unit and rotationally supported by a supporting shaft 36. The supporting shaft 36 is fixed to the casing 23 and the cover 24 so that an axis of the supporting shaft 36 is in parallel to the rotational shaft 21a of the electric motor 21. The large-diameter gear 33a of the third reduction gear 33 is engaged with the small-diameter gear 32b of the second reduction gear 32.

The output shaft 34a is formed at a center portion of the fourth reduction gear 34 and the supporting shaft 37, which outwardly protrudes in an axial direction, is fixed to the output shaft 34a. The supporting shaft 37 rotationally supports the second reduction gear 32 and an outward end of the shaft 37 is rotationally supported by the cover 24. Further, the supporting shaft 37 is disposed on the axis line L1 so that a rotational axis thereof is coaxial with the screw shaft 12. An inward end of the output shaft 34a is rotationally supported by the casing 23 and at this end there is formed an interconnecting concave portion 34b having a pair of flat surfaces. The interconnecting protruding portion 12d of the screw shaft 12 is inserted into the interconnecting concave portion 34b, so that the interconnecting protruding and concave portions 12d and 34b are engaged with each other to enable a transmission of rotational force from the output shaft 34a to the screw shaft 12.

A pipe portion 24b, which has a through-hole 24a of a circular cross-sectional configuration, is formed in the cover 24 at such a position at which the through-hole 24a is opposing to the front end of the pinion 30. An axis line of the pipe portion 24b is coaxial with the axis line L2 of the electric motor 21 (the rotational shaft 21a). An interconnecting portion (concave) 30a is formed at a center of the front end of the pinion 30, wherein a machine tool 27, for example shown in FIG. 3, will be connected. In this embodiment, the configuration of the interconnecting concave 30a is so made to be connectable with a slotted or Phillips screwdriver, which is usually equipped to a motor vehicle as an in-vehicle machine tool. In this embodiment, therefore, the machine tool 27 is a screw driver. Furthermore, in this embodiment, an inner diameter of the pipe portion 24b (a diameter of the through-hole 24a) is almost the same to a diameter of a shaft portion 27a of the machine tool 27, wherein the inner diameter of the pipe portion 24b is sufficiently large so that the shaft portion 27a can be inserted therethrough. Furthermore, a longitudinal length of the through-hole 24a is so made to be larger than the inner diameter thereof.

When the machine tool 27 is inserted into the inside of the casing 23 through the through-hole 24a and connected with the pinion 30 so that the pinion 30 can be manually rotated by the machine tool 27. Accordingly, when the parking brake is operated by the electric motor 21 by moving forward the brake piston 6 and thereafter the electric motor 21 becomes out of operation, the pinion 30 can be rotated by the machine tool 27 to backwardly move the brake piston 6 and release the parking brake.

A breathing pipe 26 made of elastic material, such as rubber, is detachably provided at its one end to the pipe portion 24b. This end of the breathing pipe 26 is extending outwardly from the pipe portion 24b along an axis line of the pipe portion 24b (in this embodiment, the axis line L2). Another end of the breathing pipe 26 extends to a passenger room (not shown), where there are little extraneous material, such as rain water, dust and so on, coming into the breathing pipe 26. As a result, the extraneous material is prevented from coming into the inside of the actuator 3 through the pipe portion 24b. Furthermore, since air flows through the through-hole 24a and the pipe 26 between the inside of the actuator 3 and the passenger room, air pressure difference between the inside and outside of the actuator 3 may not appear. As above, the through-hole 24a is used as a hole for the machine tool 27 and also as the breathing hole. Furthermore, the breathing pipe 26 has a function that prevents the extraneous material from coming into the inside of the actuator 3 through the through-hole 24a in addition to the function of the breathing.

An inner diameter of the breathing pipe 26 is larger than the inner diameter of the through-hole 24a. When the breathing pipe 26 can not be detached from the pipe portion in case of a malfunction of the electric motor 21, the breathing pipe 26 will be cut away so that the machine tool 27 (the shaft portion 27a) will be inserted through the inside of the breathing pipe 26 into the through-hole 24a. As a result, the machine tool 27 can be engaged with the interconnecting concave 30a to rotate the pinion 30.

The above explained braking apparatus 1 is operated by the working fluid for the main brake (the braking operation during the motor vehicle is running) and operated by the electric motor 21 in response to the operation of the parking brake switch when parking the motor vehicle.

(The Operation of the Braking Apparatus 1 at the Normal Braking Operation)

When a pressing stroke of the brake pedal (not shown) becomes larger, the fluid pressure in the fluid operating chamber 7 increases in proportion to the pressing stroke, so that the brake piston 6 is forwardly moved towards the brake disc 10. Then the brake pads 8 and 9 will be moved and pressed against the brake disc 10. As a result, braking force is applied to the wheels (the rear wheels).

When the pressing force to the brake pedal is decreased, the fluid pressure in the fluid operating chamber 7 decreases in proportion to the released stroke of the pedal, the brake piston is backwardly moved by, for example, reaction force generated at the brake pads 8 and 9. Then the braking force will be reduced. When the brake pedal is fully released from the pressing force, the brake piston 6 further moves backwardly and thereby the brake pads 8 and 9 will be finally separated from the brake disc 10. Namely the braking force becomes zero.

(The Operation of the Braking Apparatus 1 at the Parking Brake Operation)

When the parking brake switch is turned on to operate the parking brake, electric power will be supplied to the electric motor 21 to rotate the same in the normal rotational direction. Then the electric motor 21 drives the screw shaft 12 to rotate the same in the normal rotational direction over the speed reduction mechanism 22. When the screw shaft 12 is rotated in its normal rotational direction, the nut element 13 forwardly pushes the brake piston 6, so that the brake piston 6 generates the braking force by pressing the brake pads 8 and 9 to the brake disc 10. The electric power is supplied to the electric motor 21 until a predetermined braking force is applied to the brake disc to keep the parking position of the motor vehicle, and then the supply of the electric power will be cut off.

In this operation, the brake piston 6 receives a reaction force from the brake pads 8 and 9, which are pressed against the brake disc 10, to be backwardly moved. However, since the screw shaft 12 (the screw portion 12c) and the nut element 13 operate as the self locking mechanism, the backward movement of the brake piston 6 is prevented. Accordingly, the brake piston 6 is held at its forwardly moved position, even when the electric power supply to the electric motor 21 is cut off and the pressing force of the braking pads 8 and 9, namely the braking force, is kept. (parking brake operation)

When the parking brake switch is turned on to release the parking brake, the electric power will be supplied to the electric motor 21 to rotate the same in the reversed direction. Then the electric motor 21 drives the screw shaft 12 to rotate the same in the reversed direction over the speed reduction mechanism 22. When the screw shaft 12 is rotated in the reversed direction, the nut element 13 moves in the backward direction and the pressing force to the brake piston 6 from the nut element 13 will be released. The electric motor 21 is rotated in the reversed direction until the nut element 13 comes back to a predetermined position at which the brake pads 8 and 9 are separated from the brake disc 10 by a predetermined distance. And thereafter the supply of the electric power to the electric motor 21 is cut off. As above, the braking force becomes zero (the release of the parking brake).

When the electric motor 21 goes out of order due to some reasons after the parking brake is operated, the braking force is kept and thereby it becomes an obstacle for moving the motor vehicle. In this occasion, the breathing pipe 26 is taken away from the pipe portion 24b, the machine tool 27 (for example, a slotted or Phillips screwdriver) is inserted into the through-hole 24a to engage the front end of the screwdriver with the interconnecting concave 30a of the pinion 30. Then, the screw shaft 12 is rotated in the reversed direction by the machine tool 27 to move the nut element 13 in the backward direction on the screw portion 12c.

Since the inner diameter of the pipe portion 24b (diameter of the through-hole 24a) is made almost equal to (a little bit larger than) the diameter of front portion 27a of the machine tool 27, the machine tool 27 is prevented from being largely inclined against the axis line L1 of the pinion 30 (the rotational axis 21a). Furthermore, since the front portion 27a of the machine tool 27 is rotationally supported by the pipe portion 24b, the operation of the machine tool 27 can be easily done. In particular, since the longitudinal length of the through-hole 24a is made to be larger than the inner diameter thereof, the machine tool 27 can be held more stably by the through-hole 24a and the workability will be increased.

When the nut element 13 is moved backwardly on the screw portion 12c by the operation of the machine tool 27, the brake piston is released from the pressure from the nut element 13 and moved backwardly due to the reaction force at the brake pads 8 and 9. As above, the braking force of the parking brake can be released from the outside by separating the brake pads 8 and 9 from the brake disc 10 by means of the machine tool 27.

According to the above mentioned embodiment, there are the following advantages.

(i) Since the breathing pipe 26 makes it possible to breath through the through-hole 24a and to prevent the extraneous material from coming into the actuator 3, those two functions can be obtained by one element to reduce the number of parts.

(ii) Since the axis line L2 of the electric motor 21, on which the machine tool 27 is operated, is parallel to the wheel axis (not shown), the machine tool 27 can be operated without causing interference with the wheel axis.

(iii) Since the pinion 30, to which the interconnecting concave 30a is provided, is the closest gear to the electric motor 21 among the gears of the speed reduction mechanism 22, the torque required for rotating the gears of the mechanism 22 by the machine tool 27 is the smallest.

(iv) Since the pipe portion 24b is outwardly protruded from the cover 24, the breathing pipe 26 can be easily attached to and detached from the pipe portion 24b. Furthermore, the machine tool 27 can be easily inserted into the through-hole 24a, even when the through-hole 24a is placed in a blind position and shall be blindly groped for, because the pipe portion 24b is outwardly protruded from the cover 24.

(v) Since the configuration of the interconnecting concave 30a is so made to be connectable with the screwdriver, which is usually equipped to a motor vehicle as an in-vehicle machine tool, it is not necessary to prepare a special machine tool.

(vi) The end of the breathing pipe 26 is extending outwardly from the pipe portion 24b along the axis line of the pipe portion 24b. A space left after the breathing pipe 26 is detached from the pipe portion 24b can be used as a apace for inserting the machine tool 27 into the through-hole 24a, wherein the machine tool can be easily aligned to the axis line of the through-hole 24a, and therefore the workability will be increased.

(Other Embodiments and Modifications)

The above described embodiment can be further modified in the following manners.

Other machine tools than the flat head or Phillips screwdriver can be used. In such case, the configuration of the interconnecting portion 30a can be changed to other forms instead of the straight line or the cross line, and the interconnecting portion 30a can be the convex instead of the concave.

The configuration of the through-hole 24a should not be limited to the circular form, and any other forms can be possible. For example, a pair of grooves 24c can be further formed to the through-hole 24a as shown in FIG. 5. In case of the Phillips screwdriver, the diameter of the front end 27b is almost the same to that of the shaft portion 27a, as shown in FIG. 6A, while in case of the flat head screw driver, the width of the front end portion 27d is larger than the diameter of the shaft portion 27a, as shown in FIG. 6B. Accordingly, when the pair of the grooves 24c is formed at the through-hole 24a, the flat head screwdriver can be inserted into the through-hole 24a and the shaft portion 27a of the driver can be rotationally held by the through-hole 24a, in which the inclination of the driver can be minimized.

The interconnecting portion 30a can be provided at other gears than the pinion 30.

In the above embodiment, the pipe portion 24b is formed to connect the breathing pipe 26 to the through-hole 24a. It is preferable to provide a flange portion extending in a radial direction at an outer peripheral surface of the pipe portion 24b, so that it is prevented that the breathing pipe 26 will be easily detached from the pipe portion 24b.

In the above embodiment, the breathing pipe 26 is made of elastic material, such as rubber. However, any other material, for example, oil resistance material which is anti-corrosive to the brake oil can be preferably used.

In the embodiment, the main braking force is applied to the brake disc by the working fluid. The electric motor can be, however, used for applying the main and parking braking forces.

The present invention can be applied not only to the disc-type brake system but also to the drum-type brake system.

What is claimed is:

1. A braking apparatus for a motor vehicle comprising:
a main braking device for applying braking force to wheels of the motor vehicle in response to a press stroke of a brake pedal;
a parking brake device operatively connected to the main braking device for applying parking brake force to the wheels at parking the motor vehicle, the parking brake device having a housing, an electric motor housed in the housing, and a speed reduction mechanism having at least one gear and also housed in the housing, so that the rotational force of the electric motor is transmitted to the main braking device over the speed reduction mechanism to apply the parking brake force to the wheels;
a through-hole provided in the housing, through which a machine tool will be inserted to manually rotate the electric motor when the electric motor becomes out of order after the parking brake force is applied to the wheels; and
a breathing pipe connected at its one end to the through-hole and terminated at its other end at a place where there are little extraneous material.

2. A braking apparatus according to claim 1,
wherein the speed reduction mechanism of the parking brake device has an interconnecting portion, which will be engaged with the machine tool and which is provided on a side surface and a center portion of the gear, and
wherein the through-hole is coaxial with the interconnecting portion.

3. A braking apparatus according to one of claims 1 and 2,
wherein the speed reduction mechanism of the parking brake device has multiple gears for reducing the rotational speed of the electric motor, and
wherein the gear, to which the interconnecting portion is provided, is the closest gear to the electric motor.

4. A braking apparatus according to one of claims 1 and 2,
wherein a pipe portion outwardly protruding from the housing is further provided at the through-hole, so that the one end of the breathing pipe is attached to the pipe portion.

5. A braking apparatus according to one of claims 1 and 2,
wherein the speed reduction mechanism of the parking brake device has multiple gears for reducing the rotational speed of the electric motor,
wherein the gear, to which the interconnecting portion is provided, is the closest gear to the electric motor, and
wherein a pipe portion outwardly protruding from the housing is further provided at the through-hole, so that the one end of the breathing pipe is attached to the pipe portion.

6. A braking apparatus according to one of claims 1 and 2,
wherein a longitudinal length of the through-hole is made to be larger than an inner diameter of the through-hole.

7. A braking apparatus according to one of claims 1 and 2,
wherein an end of the breathing pipe, which is connected to the through-hole, extends outwardly from the through-hole along an axis of the through-hole.
